(19) United States
(12) Patent Application Publication
(10) Pub. No.: US 2014/0014380 A1
(43) Pub. Date: Jan. 16, 2014

(54) FLEXIBLE DISC FOR A DISC SEEDING COULTER

(71) Applicant: Michael Budde, Anrochte (DE)

(72) Inventor: Michael Budde, Anrochte (DE)

(73) Assignee: KVERNELAND AS, Kvernaland (NO)

(21) Appl. No.: 14/007,675

(22) PCT Filed: May 24, 2012
(86) PCT No.: PCT/EP2012/059721

§ 371 Date: Sep. 26, 2013

(30) Foreign Application Priority Data
Jun. 10, 2011 (DE) 10 2011 051 026.5

(51) Int. Cl. A01B 15/16; A01C 5/06; A01B 15/18

(52) U.S. Cl. CPC A01B 15/16; A01B 15/18; A01C 5/064
USPC 172/559

(57) ABSTRACT

A flexible disc for rotary accommodation on a coulter mount of a disc coulter relative to a cutting disc for opening of the soil (A), the flexible disc arranged to brush over a cleaning surface of the cutting disc. Furthermore, this invention relates to a disc coulter with an outlet section for feed of seed and/or fertilizer between a cutting disc and an at least partially flexible disc, with a coulter mount for rotational accommodation of the cutting disc for opening the soil (A) and of a flexible disc which brushes over a cleaning surface of a cleaning side of the cutting disc, which side faces the outlet section.

The invention relates to a flexible disc for rotary accommodation on a coulter mount of a disc coulter as claimed in claim 1 and a disc coulter with an opening section designed for feed of seed and/or fertilizer between a cutting disc and one at least partially flexible disc as claimed in claim 2.

Generic prior art which describes the fundamental manner of operation of this disc coulter is disclosed in EP 0 579 909 B2.

As described in EP 0 579 909 B2 there is furthermore a need for an improvement of the cleaning of the cutting disc so that the object of this invention is to optimize the flexible disc which is used as a cleaning disc and to optimize a corresponding disc coulter with respect to its cleaning action.

With respect to the flexible disc the object is achieved with the features of claim 1 and with respect to the disc coulter with the features of claim 2.

Advantageous developments of the invention are given in the dependent claims. All combinations of at least two of the features given in the specification, the claims and/or the figures also fall within the scope of the invention. At the given value ranges, values within the indicated limits will also be considered to be disclosed as boundary values and will be claimed in any combination. Features of the disc coulter comprise at least indirectly also features of the flexible disc and vice versa.

This invention is based on the idea of achieving improved cleaning action by changing the shape of the outer contour of the flexible disc since the active cleaning surface between the cutting disc and the flexible disc is enlarged. Here especially there is a different rotation speed of the cutting disc relative to the flexible disc. Since the flexible disc is made to be elastically deformable in a compliant manner, on the outer contour in the plane of rotation of the flexible disc the contact pressure is different, due to the different distances of the outer contour of the flexible disc to the center, the area center of gravity or the axis of rotation. The maximum apex distance D deviates not only by production tolerances from the minimum apex distance d, i.e. therefore especially by more than 1%, preferably at least by 3%, still more preferable at least by 5%. Here it is especially conceivable that the minimum apex distance d is formed by a shape which is curved or concave to the center, the area surface of gravity, or the axis of rotation. The configuration as claimed in the invention yields not only a larger active cleaning surface between the cutting disc and the flexible disc, but also improved release of any articles trapped between the cutting disc and the flexible disc, for example small stones.

Especially effective cleaning of the cutting disc is achieved by the flexible disc in its plane of rotation having an at least largely, especially completely convex, especially oval, preferably elliptical outer contour.

Advantageously the flexible disc according to one embodiment of the invention is formed from plastic, especially at least predominantly from a thermoplastic, preferably at least largely from a thermoplastic elastomer. These materials are on the one hand very resistant and on the other hand very advantageous for the cleaning action which is to be achieved.

The cleaning action becomes especially homogeneous by the flexible disc having a symmetrical outer contour.

In another advantageous embodiment of the invention, it is provided that the flexible disc has a curved action surface which is especially concave toward the cleaning surface for acting on the cleaning surface. In this way a pretensioning or tensioning is achieved between the flexible disc and the cutting disc and is kept constant over a long time interval. In order to effect a uniform, especially largely constant action force along the action surface when the flexible disc rotates, the action surface can be made uneven. It is especially advantageous if the uneven action surface is formed by the different thickness parallel to the axis of rotation and/or by corresponding shaping of the action surface. Here the action surface projects advantageously in the region of minimum apex distances d in the direction of the cleaning surface against the curvature of the flexible disc.

This flexible disc can be produced especially advantageously by thermoshaping or injection molding.

To the extent a flexible disc can be produced by punching out of a web-shaped (path) material, production is especially economical and precise.

According to another advantageous embodiment of the invention it is provided that the flexible disc and/or the cutting disc at least on their action surface/cleaning surface is provided with adhesion-reducing particles, especially a filler with water-repellent and/or particle-repellent properties, preferably a nanofiller. In this way adhesions of particles, especially soil, can be minimized. Nanofillers can be for example silicon dioxide.

Alternatively or in addition, according to one advantageous embodiment of the invention it can be provided that the flexible disc and/or the cutting disc be made microstructured at least on its action surface/cleaning surface. Appropriate structuring can further reduce the adhesion of water and/or particles. Microstructuring is created either by molding in an injection molding tool in an injection molding process or by an embossing process which can follow the injection molding process and optionally a thermoforming process. A coating is likewise conceivable, especially for the cutting disc which can be made of metal. The coating can be lacquer, especially lacquer which has nanoparticles.

The so-called sandwich method can be used as a special injection molding method. Here the inner core of the flexible disc of a first thermoplastic material is extrusion-coated with a thermoplastic material which forms the jacket and thus the entire outer contour of the flexible disc not only in the plane of rotation, but also on the surfaces of the flexible disc.

Both materials can consist either of the same material group or of different material groups. In the choice of the same material groups it is especially conceivable to use as the core material a recycled, more economical material and as the outer jacket on the outer contour especially the same material as new material. Other conceivable combinations are the combination of a more economical material for the core material which then assumes the function of a filler material, with a high-price, especially other material which as a technical material performs the actual function of the flexible disc, or material pairings which satisfy the in part contrary properties of higher strength (first material) and higher flexibility (second material). Both materials can adhere with respect to their chemical composition after the production process. Since the second material jackets the first material, it is often sufficient if purely mechanical adhesion can be effected by interlocking due to geometrical arrangements.

According to one alternative embodiment of the invention it is conceivable to produce the flexible disc by injection molding methods by means of extrusion-coating of the periphery of a steel disc with a thermoplastic material. This material can have especially good adhesiveness to metal so that extrusion-coating onto the steel disc can take place without further arrangements. The adhesion takes place by means of a peripheral steel/plastic composite, the two materials overlapping in a width of especially 1 cm to 4 cm. To the extent as claimed in the invention a thermoplastic material is used which does not join a metal by itself, the composite can be produced by so-called undercuts. These undercuts can be formed especially by holes being made along the periphery of the steel disc. By means of an injection molding process the two peripheral sides of the steel disc are extrusion-coated with the thermoplastic material, the thermoplastic material penetrating the holes and thus forming a forced adhesive connection of the thermoplastic material to the steel disc.

Other advantages, features and details of the invention will become apparent from the following description of preferred exemplary embodiments and using the drawings.

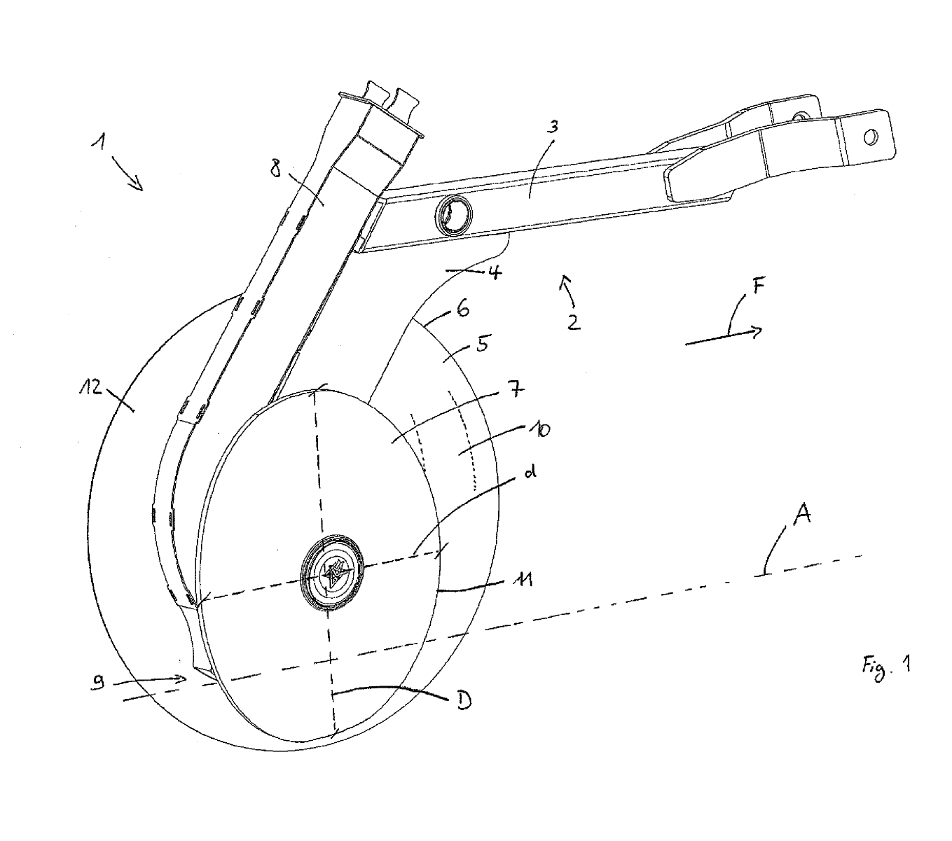

FIG. 1 shows a perspective view of a disc coulter as claimed in the invention with a flexible disc in a first rotation position and

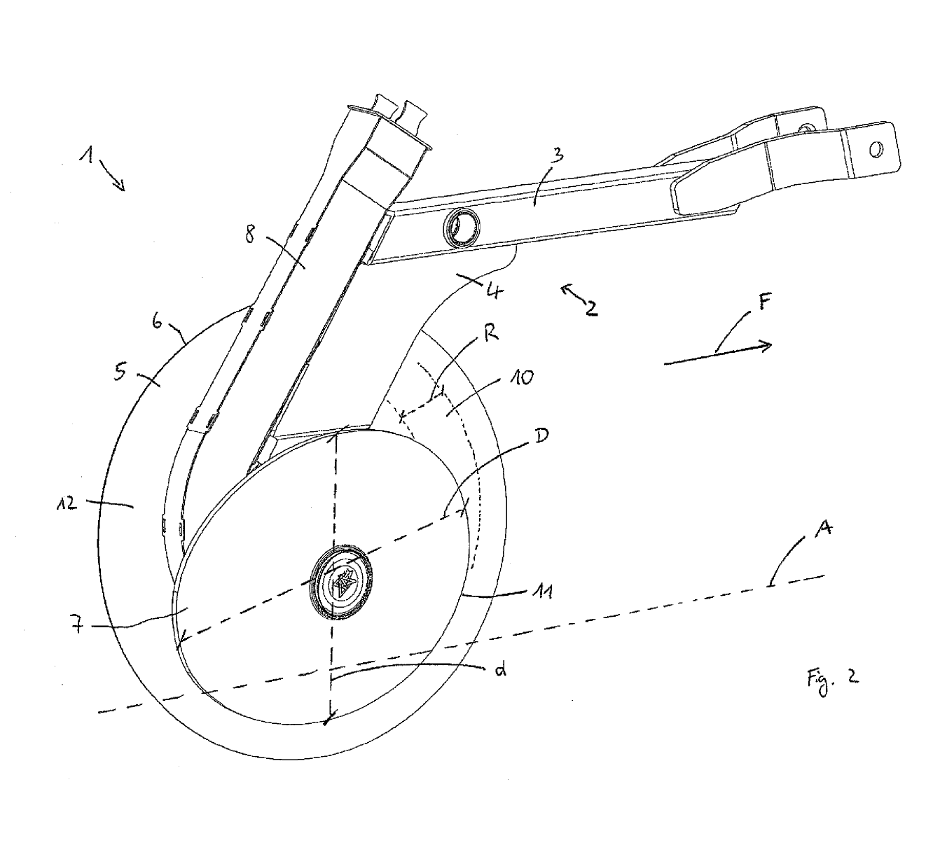

FIG. 2 shows a disc coulter according to FIG. 1 with a flexible disc in a second position which has been turned by roughly 90°.

In the figures the same components or components with the same function are identified with the same reference numbers.

The fundamental structure of a seed and/or fertilizer distributing machine as claimed in the invention, hereinafter for the sake of simplicity called a distributing machine which is intended to accommodate a series of seeding coulters as claimed in the invention, is not shown and is assumed to be known. The direction F of travel is shown by the arrow (to the right in the plane of the drawings of the figures). In the exemplary embodiment the invention is shown using a pneumatic distributing machine. The invention can also be used in the same way for a seed drill.

The disc coulter 1 which is shown in FIGS. 1 and 2 has a coulter mount 2 with a mount 4 which is attached to a retaining pipe 3, and a cutting disc 5 which is rotationally mounted on a shaft which is hidden in the views according to FIGS. 1 and 2. The cutting disc 5 has a circular outer contour 6 which can be made with or without toothing.

A flexible disc 7 is rotationally mounted on a second shaft, the two shafts being located on the mount 4 in the conventional manner at an angle to one another so that the discs 5, 7 can rotate accordingly angled to one another.

Furthermore the disc coulter 1 comprises a feed line 8 for granular material (seed/fertilizer), the feed line 8 on its lower region discharging into an outlet section 9 of the disc coulter 1 which is located between the cutting disc 5 and the flexible disc 7. The feed line 8 on its other end can be connected to a proportioning apparatus (not shown) for proportioning of the granular material.

While the steel cutting disc 5 is used to open the soil A while traveling in the direction F, the flexible disc 7 which is made smaller than the cutting disc 5 is used primarily for protection of the outlet section 9 and for cleaning of the cutting disc 5 against any material of the soil A or from the soil A adhering to the cutting disc 5.

The flexible disc 7 has been produced as a thermoplastic elastomer by punching out of a web of thermoplastic elastomer and has a curvature which has been formed by a thermoforming process and which is made concave compared to the cutting disc 5. For this reason the minimum d and maximum D apex distances of the flexible disc 7 which are shown in FIGS. 1 and 2 seemingly do not run through the axis of rotation of the flexible disc 7 due to the perspective in FIGS. 1 and 2. In a plan view they would run through the axis of rotation which preferably coincides with the area center of gravity of the flexible disc 7.

The flexible disc 7 in this exemplary embodiment has an outer contour 11 which is elliptical in this exemplary embodiment with the maximum apex distance D and the minimum apex distance d. The different circumferences of the cutting disc 5 and the flexible disc 7 yields a different rotation speed of the cutting disc 5 compared to the rotation speed of the flexible disc 7 so that during operation, therefore delivery of seed/fertilizer, a different peripheral section of the outer contour 11 with an action surface which points at the cutting disc 5 brushes over one cleaning side 12 of the cutting disc 5 again and again. The elliptical shape of the flexible disc 7 together with the angled arrangement of the flexible disc 7 relative to the cutting disc 5 yields an effective annular cleaning surface 10 which compared to a round flexible disc from the prior art has a larger ring width R. The ring width R is enlarged roughly by the difference of the maximum apex distance D to the minimum apex distance d.

In addition, on the periphery or the outer contour 11 of the flexible disc 7 different contact pressures arise so that also any trapped articles are more easily released.

### REFERENCE NUMBER LIST

1 disc coulter
2 coulter mount
3 retaining pipe
4 mount
5 cutting disc
6 outer contour
7 flexible disc
8 feed line
9 outlet section
10 cleaning surface
11 outer contour
12 cleaning side
d minimum apex distance
D maximum apex distance
F direction of travel
A soil
R ring width

1-10. (canceled)

11. A flexible disc for rotary accommodation on a coulter mount of a disc coulter relative to a cutting disc for opening of soil,
said flexible disc rotationally supported such that it brushes over a cleaning surface of the cutting disc, and
said flexible disc made elastically deformable in a compliant manner and its plane of rotation has a maximum apex distance (D) and a minimum apex distance (d) which differs from the maximum apex distance (D).

12. A disc coulter comprising:
a cutting disc for opening soil, said cutting disc having a cleaning side with a cleaning surface,
an at least partially flexible disc which brushes over the cleaning surface,
an outlet section for feed of seed and/or fertilizer between the cutting disc and the at least partially flexible disc, wherein the cleaning side of the cutting disc faces the outlet section,
a coulter mount for rotational accommodation of the cutting disc and the flexible disc,
wherein the flexible disc in its plane of rotation has a maximum apex distance (D) and a minimum apex distance (d) which differs from the maximum apex distance (D).

13. The disc coulter as claimed in claim 12, wherein the flexible disc has an at least largely convex outer contour in its plane of rotation.

14. The disc coulter as claimed in claim 12, wherein the flexible disc is formed from plastic.

15. The disc coulter as claimed in claim 12, wherein the flexible disc has a symmetrical outer contour.

16. The disc coulter as claimed in claim 12, wherein the flexible disc has a curved action surface which is concave toward the cleaning surface, for acting on the cleaning surface.

17. The disc coulter as claimed in claim 12, wherein the flexible disc is produced at least partially by thermoforming or injection molding methods.

18. The disc coulter as claimed in claim 12, wherein the flexible disc is produced by punching out of a web-shaped material.

19. The disc coulter as claimed in claim 12, wherein the the cutting disc is provided with adhesion-reducing particles at least on the cleaning surface.

20. The disc coulter as claimed in claim 12, wherein the cutting disc is made microstructured at least on the cleaning surface.

21. The disc coulter as claimed in claim 13, wherein the flexible disc has a completely convex outer contour in its plane of rotation.

22. The disc coulter as claimed in claim 11, wherein the flexible disc has an oval outer contour in its plane of rotation.

23. The disc coulter as claimed in claim 11, wherein the flexible disc has an elliptical outer contour in its plane of rotation.

24. The disc coulter as claimed in claim 14, wherein the flexible disc is formed at least largely from a thermoplastic.

25. The disc coulter as claimed in claim 14, wherein the flexible disc is formed at least largely from a thermoplastic elastomer.

26. The disc coulter as claimed in claim 16, wherein the flexible disc is provided with adhesion-reducing particles at least on the action surface.

27. The disc coulter as claimed in claim 26, wherein the adhesion-reducing particles include a filler with water-repellant and/or particle-repellent properties.

28. The disc coulter as claimed in claim 27, wherein the filler is a nanofiller.

29. The disc coulter as claimed in claim 16, wherein the flexible disc is made microstructured at least on the action surface.

30. The disc coulter as claimed in claim 16, wherein the action surface of the flexible disc is produced at least partially by thermoforming or injection molding methods.

31. The disc coulter as claimed in claim 30, wherein the flexible disc is produced at least partially with different material layers.

32. The disc coulter as claimed in claim 19, wherein the adhesion-reducing particles include a filler with water-repellant and/or particle-repellent properties.

33. The disc coulter as claimed in claim 32, wherein the filler is a nanofiller.
